(19) United States
(12) Patent Application Publication
(10) Pub. No.: US 2024/0220571 A1
(43) Pub. Date: Jul. 4, 2024

(54) VECTORIZED SPARSE CONVOLUTION

(71) Applicant: QUALCOMM Incorporated, San Diego, CA (US)

(72) Inventors: Nilaykumar Kantibhai PATEL, Nadiad (IN); Michael CASTELLOE, San Diego, CA (US)

(21) Appl. No.: 18/147,330

(22) Filed: Dec. 28, 2022

(51) Int. Cl. G06F 17/15

(52) U.S. Cl. CPC G06F 17/15

(57) ABSTRACT

Certain aspects of the present disclosure provide techniques and apparatus for vectorized sparse convolution. An input tensor for a convolution operation using a convolution kernel is accessed, where the input tensor comprises a set of valid elements. An aggregated output value is generated for a valid element of the set of valid elements in the input tensor, by determining a set of one or more affected output elements based on the convolution kernel; generating, for each respective affected output element of the set of one or more affected output elements, a respective intermediate value based on the convolution kernel and the valid element; and accumulating the respective intermediate values to generate the aggregated output value. The aggregated output value is output.

### INTRODUCTION

Aspects of the present disclosure relate to sparse convolution.

Deep neural networks exhibit remarkable performance in both image classification and object detection problems, at the cost of a large number of parameters and computational complexity. Sparse convolution generally refers to techniques for reducing redundancy in these parameters using a sparse decomposition.

In some cases, sparse convolution is used in deep neural networks (e.g., convolutional neural networks) where input tensors (e.g., images) have sparse valid elements (e.g., pixels). For sparse inputs, it is sometimes wasteful to perform conventional convolution, which involves a large number of multiplications for the input elements. That is, if the input is sparse (such as with a large number of elements having a null value or a value of zero), then a significant portion of some of these conventional multiplications are performed unnecessarily.

Some approaches to sparse convolution have been proposed to reduce this wasted computational expense. However, each has a number of limitations and drawbacks. For example, some conventional techniques for sparse convolution are implemented using graphics processing units (GPUs) where each operation is run by a single thread and no vectorization is involved. Such techniques prevent effective parallelization of many aspects. Further, GPUs often use substantial power and other computational resources, as compared to other processors such as digital signal processors (DSPs). Some conventional sparse convolution techniques cannot be effectively or efficiently performed using such limited hardware and resources.

### BRIEF SUMMARY

Certain aspects provide a method, including accessing an input tensor for a convolution operation using a convolution kernel, wherein the input tensor comprises a set of valid elements; generating an aggregated output value for a valid element of the set of valid elements in the input tensor, comprising: determining a set of one or more affected output elements based on the convolution kernel; generating, for each respective affected output element of the set of one or more affected output elements, a respective intermediate value based on the convolution kernel and the valid element; and accumulating the respective intermediate values to generate the aggregated output value; and outputting the aggregated output value.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and apparatus comprising means for performing the aforementioned methods as well as those further described herein.

The following description and the related drawings set forth in detail certain illustrative features of one or more aspects.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 depicts an example workflow for performing sparse convolutions.

FIGS. 2A, 2B, and 2C depict example workflows for performing vectorized sparse convolution.

FIG. 3 is a flow diagram depicting an example method for performing sparse convolution using scatter-accumulate techniques.

FIG. 4 is a flow diagram depicting an example method for sparse convolution.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for improved sparse convolution.

Sparse convolution generally refers to techniques for reducing redundancy and/or wasted computational expense in performing inferencing based on sparse input data using machine learning models. For example, the large number of parameters and/or operations associated with deep neural networks may involve substantial computational expense, much of which may be avoided if sparse processing is appropriately used. In some aspects, sparse convolution may involve performing individual convolution operations for specific locations/indices of valid values or elements (e.g., values with a non-zero value), while refraining from processing other locations/indices of invalid or empty values or elements. In contrast, some conventional matrix multiplication approaches for sparse convolution may be extremely inefficient. Further, some conventional approaches for sparse convolution have been optimized to run on graphics processing units (GPUs) where each operation is run by a single thread and no vectorization is involved. These approaches remain inefficient and consume substantial power.

In some aspects of the present disclosure, techniques for parallelized (e.g., multithreaded), vectorized, and/or single instruction multiple data (SIMD) operations are used to implement sparse convolution, which provides a variety of advantages over some conventional approaches. For example, some aspects of the techniques disclosed herein may use thread level parallelism, along with SIMD operations and/or a scatter-accumulate feature (which may also be referred to as a scatter-gather feature), to accelerate convolution operations (along with other vector operations in some aspects to further accelerate remaining calculations). As discussed in greater detail below, thread-level parallelization may be used for various operations where some conventional sparse convolution techniques are incompatible with thread-level parallelization. Further, as discussed above, some conventional techniques are optimized for use with GPUs, which consume substantial power. In contrast, some aspects of the present disclosure provide techniques that may run on SIMD engines and/or digital signal processors (DSPs) which may use significantly less power or other resources.

As used herein, data, such as input tensors, may be referred to as “sparse” to indicate that the data includes one or more invalid or irrelevant values or elements. In some aspects, the data may be referred to as sparse to indicate that the data meets one or more sparsity criteria, such as a threshold number or percentage of invalid elements. As used herein, an element or value may be referred to as “invalid” to indicate that the element or value has no value, or has a value indicating that the element is irrelevant to the output (e.g., a value of zero or a null value). Similarly, an element or value may be referred to as “valid” to indicate that the element or value has a value that is relevant or meaningful value (e.g., a non-zero value). For example, a tensor of LIDAR data may be sparse in that a relatively large portion of the elements have a value of zero, while the “valid” elements include non-zero values.

In some aspects, affected output elements in an output tensor are identified for each valid element in the input data (e.g., where the output tensor may have a corresponding size, shape, and/or dimensionality to the input tensor). In some aspects, the affected output elements are identified based at least in part on the convolution operation being applied. For example, for convolution using a 3×3 kernel (also referred to as a mask in some aspects), each valid input element may have nine affected or relevant output elements. That is, the affected output elements may be the elements, in the output tensor, where the value of the element is determined based at least in part on the value of the given valid input element, as discussed in more detail below. In some aspects, this determination or identification of affected output elements can be performed in parallel for some or all of the valid input elements (e.g., using multiple threads).

In some aspects, the system can then apply the convolution operation for each valid input element based on the kernel weights and the corresponding set of affected output elements. For example, as discussed in more detail below, the system may perform multiplications between the value of the valid element and each weight of the kernel to determine intermediate value(s) (also referred to as convolution values or intermediate convolution values, in some aspects). In some aspects, the convolution operation can be applied for multiple affected output elements of a given input element in parallel (e.g., using SIMD operations or multiple threads), and/or may be applied for the affected output elements of multiple valid input elements in parallel.

In some aspects, these intermediate values (generated for each valid input element) can be accumulated, with respect to the output element indices, using a buffer for example, which may be alternatively referred to scatter-gather or scatter-accumulate process. In some aspects, the buffer includes a set of elements, where each element in the buffer corresponds to a given output or input element index. To accumulate the intermediate values for a given output element (generated based on one or more valid input elements), as discussed in more detail below, the system can identify the corresponding buffer element and push each intermediate value into the buffer (e.g., summing the newly generated intermediate value with the value already contained in the identified buffer element, if any). In some aspects, the accumulation process can be performed for each valid input element and/or each output element in parallel and/or asynchronously (e.g., using multiple threads).

In some aspects, the system can then perform a gather or collection operation to generate the output of the sparse convolution. For example, the system may determine to output the generated values only for “valid” output elements, which may be defined as output elements having the same index as a “valid” input element, as discussed in more detail below. In some aspects, this gathering operation can similarly be performed in parallel and/or asynchronously for each valid output (e.g., using multiple threads).

Advantageously, these sparse convolution techniques can be performed substantially more efficiently than some conventional approaches, with reduced computational expense and/or power consumption, and/or with reduced or simplified hardware (e.g., using DSPs rather than GPUs).

### Example Workflow for Performing Sparse Convolutions

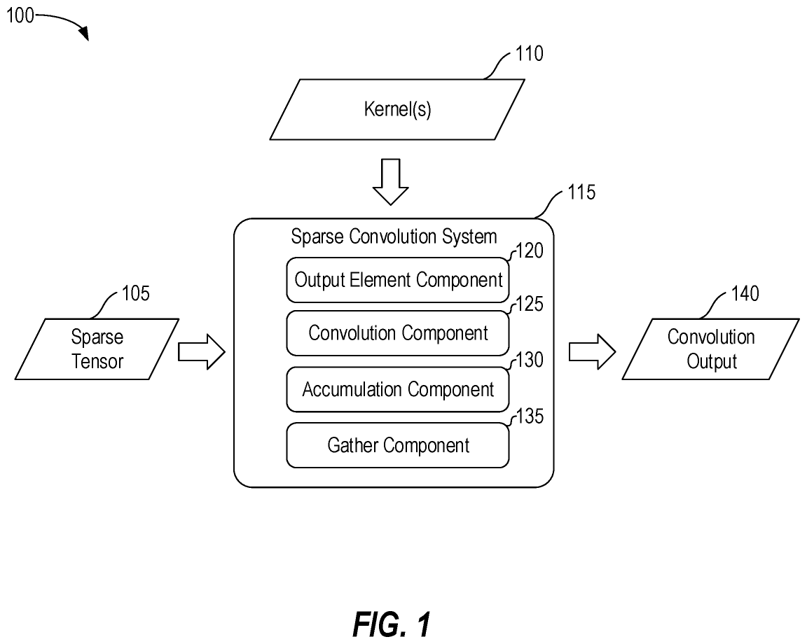

FIG. 1 depicts an example workflow 100 for performing sparse convolutions.

In the illustrated workflow 100, a sparse tensor 105 is accessed, by a sparse convolution system 115, to be convolved with one or more kernels 110 (also referred to in some aspects as masks). As used herein, “accessing” data can generally include receiving, requesting, retrieving, or otherwise gaining access to the data. Although the illustrated workflow 100 suggests the sparse convolution system 115 accessing the sparse tensor 105 and kernels 110 from external sources for conceptual clarity, in some aspects, some or all of the sparse tensors 105 and kernels 110 may be accessed from local sources within the sparse convolution system 115. In some aspects, the workflow 100 corresponds to an inferencing operation, such as where input tensors are processed using trained or learned kernels to generate output. In some aspects, the workflow 100 may additionally or alternatively be performed during training, such as during the forward pass of training a convolutional neural network.

Additionally, although the sparse convolution system 115 is depicted as a discrete system for conceptual clarity, in some aspects, the operations of the sparse convolution system 115 may be implemented as part of a broader system, may be combined or distributed across any number and variety of components, and may be implemented using hardware, software, or a combination of hardware and software. In at least one aspect, the sparse convolution system 115 is used to process data being passed through a convolution operation, such as in a convolutional neural network.

In an aspect, the sparse tensor 105 generally corresponds to a set of data elements (e.g., pixels) in one or more dimensions (e.g., a two-dimensional tensor, or a three-dimensional tensor), where some subset of the elements are invalid (e.g., having a value of zero or a null value) and some subset are valid (e.g., having non-zero values). In some aspects, the sparse convolution system 115 accesses the entire sparse tensor, including the invalid elements. In at least some aspects, the sparse convolution system 115 accesses only the subset of valid elements. For example, in some aspects, the sparse tensor 105 may be provided as a set of valid values and a corresponding set of indices indicating the position of each valid value in the original tensor, as discussed in more detail below. Generally, the content of the sparse tensor 105 may vary depending on the particular implementation. For example, in some cases, the sparse tensor 105 comprises LIDAR data from one or more LIDAR sensors, and/or feature data generated or extracted from LIDAR data (e.g., by a prior layer of a neural network).

As illustrated, the sparse convolution system 115 convolves the sparse tensor 105 with one or more kernels 110 to generate convolution output 140. As discussed above, each kernel 110 generally specifies a set of weights or values (e.g., learned during training) to be convolved (e.g., multiplied) with the input sparse tensor 105.

In the illustrated example, the sparse convolution system 115 includes several components to perform the sparse convolution, including an output element component 120, a convolution component 125, an accumulation component 130, and a gather component 135. Although several discrete components are depicted for conceptual clarity, in aspects, the operations of each may be combined or distributed across any number and variety of components.

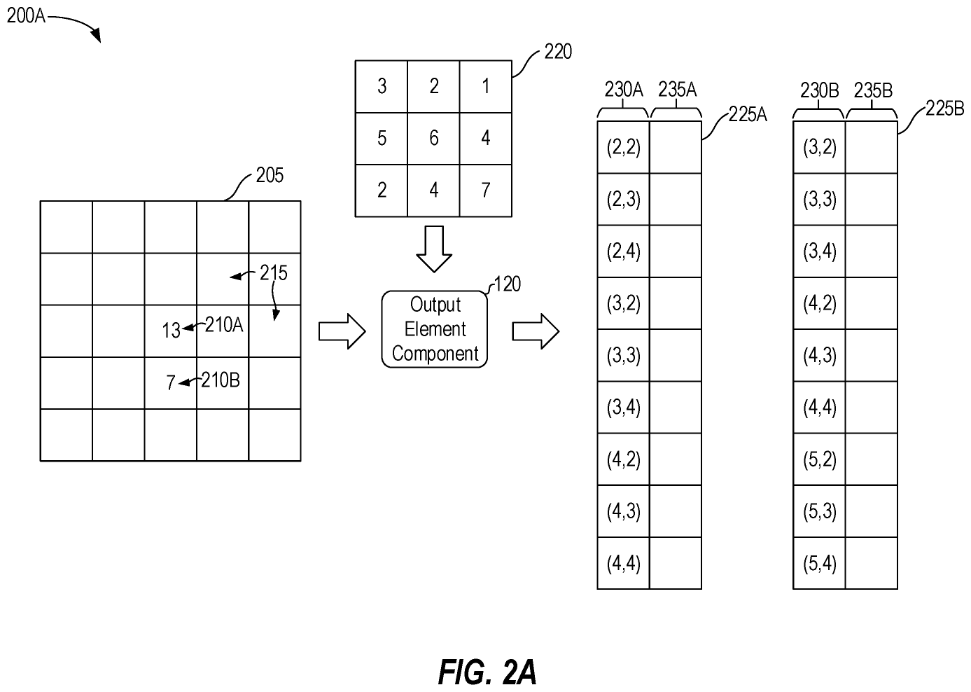

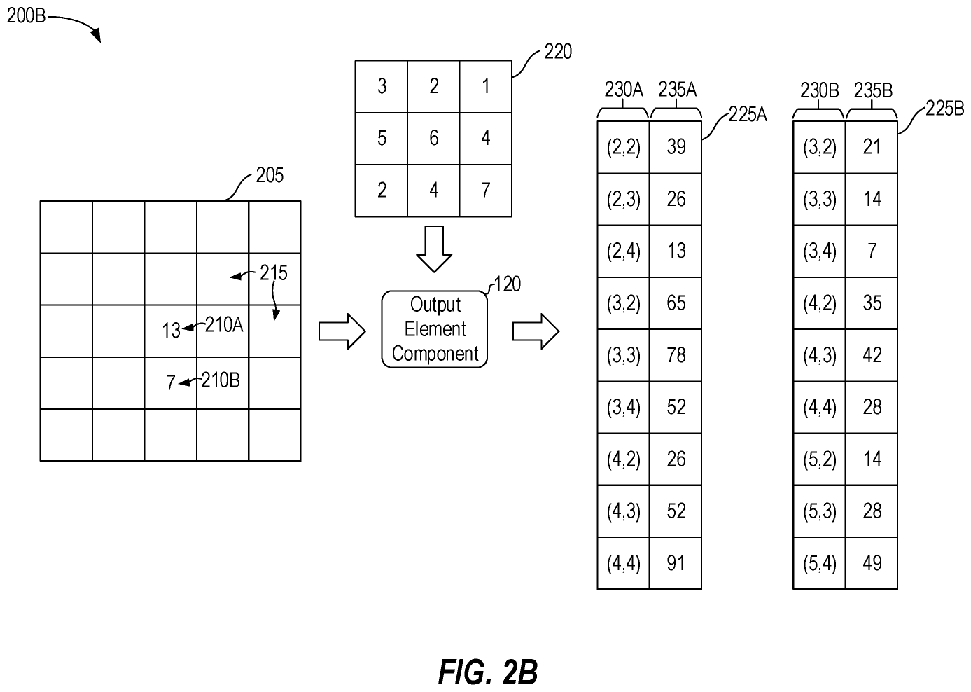

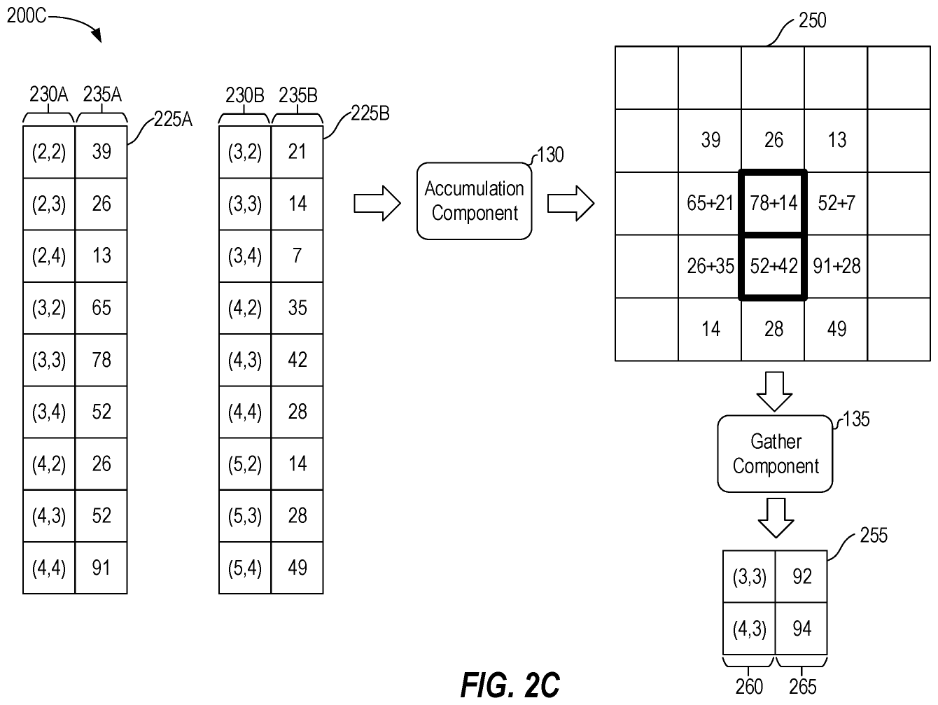

In some aspects, the output element component 120 is generally used to identify, for each valid input element in the sparse tensor 105, a corresponding set of affected output elements, as discussed in more detail below with reference to FIG. 2A. In at least one aspect, the output element component 120 identifies the affected output element for each valid input element based on the size, shape, and/or dimensionality of the kernel 110.

In one aspect, to identify affected output elements, the output element component 120 may identify the element indices that are covered by the kernel 110 when the kernel 110 is centered on the index of the valid input element (or otherwise located or positioned in a defined place, relative to the valid input element). For example, if a valid input element is located at index (3, 3) (e.g., row 3 column 3) and the kernel 110 has a height and width of three, then the corresponding output elements/indices may be (3, 3) (the center of the kernel), (2, 2) (e.g., row 2 column 2, for the top-left element of the kernel), (2, 3) (e.g., row 2 column 3, for the top-center element of the kernel), (2, 4) (e.g., row 2 column 4, for the top-right element of the kernel), (3, 2) (e.g., row 3 column 2, for the center-left element of the kernel), (3,4) (e.g., row 3 column 4, for the center-right element of the kernel), (4, 2) (e.g., row 4 column 2, for the bottom-left element of the kernel), (4, 3) (e.g., row 4 column 3, for the bottom-center element of the kernel), and (4,4) (e.g., row 4 column 4, for the bottom-right element of the kernel).

In the illustrated example, the convolution component 125 may be used to compute or generate intermediate values for each affected output element, as discussed in more detail below with reference to FIG. 2B. In some aspects, the convolution component 125 does so by, for each valid input element, multiplying the value of the valid element with each weight or value specified in the kernel 110. In some aspects, the convolution component 125 can process one or more of the valid inputs in parallel and/or asynchronously (e.g., using multiple threads).

In some aspects, the accumulation component 130 can then accumulate these generated intermediate values on a per-output element or per-index basis. For example, as discussed below in more detail with reference to FIG. 2C, for each generated intermediate value, a corresponding buffer element may be identified. That is, each index in the input and/or output tensor may have a corresponding buffer element or bucket in a buffer, and the intermediate values generated for each may be added to the corresponding buffer element (such as by summing each intermediate value with the value that is already in the buffer element, if any).

For example, the buffer elements may be pre-set to zero, and each time an intermediate value is generated or available (e.g., each time a given input element finishes processing), the value in the corresponding buffer can be determined and summed with the newly generated value. The sum is then stored back to the buffer element. In some aspects, the buffer enables asynchronous updating such that the input elements can be processed in parallel (e.g., using multiple threads and/or a SIMD architecture). That is, regardless of the order in which the input elements are completed (e.g., if some threads in the multithreaded system finish faster), the buffer can be used to accumulate the results for each output element.

In the illustrated example, the gather component 135 can be used to perform gathering or collecting of the valid output values from the buffer, as discussed in more detail below with reference to FIG. 2C. As discussed above and in more detail below, the convolution component 125 may generate intermediate values not only at the index of the valid element, but also for one or more surrounding indices (e.g., corresponding to the receptive field of the kernel 110). In some aspects, however, only output values with the same indices of a valid input element may be considered valid. In some aspects, therefore, the gather component 135 can access these values and provide them as the convolution output 140. For example, if one valid input element in the sparse tensor 105 has an index of (3, 3), then the gather component 135 may identify the value in the buffer element that corresponds to index (3, 3) and provide the aggregated value as part of the convolution output 140. In some aspects, some or all of the output elements can be gathered in parallel and/or asynchronously (e.g., using multiple threads).

In this way, the sparse convolution system 115 can perform efficient sparse convolution using reduced computational expense and power consumption, as well as with less complex and less expensive hardware that may be more readily accessible on a wider variety of devices and systems, as compared to some conventional sparse convolution approaches.

### Example Workflows for Performing Vectorized Sparse Convolution

FIGS. 2A, 2B, and 2C depict example workflows 200A, 220B, and 200C for performing vectorized sparse convolution. In some aspects, the workflows 200A-C may be performed by a sparse convolution system, such as the sparse convolution system 115 of FIG. 1.

In some aspects, the workflows 200A-C may be referred to as implementing “vectorized” sparse convolution to indicate that one or more of the underlying operations involve vector computations, and/or that one or more pieces of intermediate data are stored or represented as vectors. In contrast, some conventional solutions perform one convolution operation at a time, without vectorization. For example, in some aspects, the input values (e.g., indicated by elements 210 in FIG. 2A, as discussed in more detail below) may be stored as scalar values (e.g., in scalar registers), while the kernel values (e.g., the parameters of the kernel 220 in FIG. 2A) may be stored as vector values (e.g., in vector registers). In an aspect, therefore, vector-scalar operations (e.g., SIMD vector-scalar multiplication) may be used to generate the intermediate values (e.g., included in the columns 235 of FIGS. 2B and 2C).

The workflow 200A, depicted in FIG. 2A, may be performed by the output element component 120 of FIG. 1. In the illustrated example, an input tensor 205 (which may correspond to a sparse tensor, such as sparse tensor 105 of FIG. 1) is accessed as input for the sparse convolution. In the illustrated example, the input tensor 205 includes one or more “valid” (e.g., non-zero) input elements 210A and 210B, as well as one or more “non-valid” or “invalid” (e.g., with a value of zero) input elements 215. Specifically, in the illustrated example, the valid input elements 210 include a value of 13 in valid input element 210A and a value of 7 at valid input element 210B. Additionally, in the illustrated example, invalid input elements 215 are depicted as blank or empty elements.

Although the illustrated example depicts an input tensor 205 having both valid and invalid elements, in some aspects, the input tensor 205 may include only valid elements (e.g., not including the invalid input elements 215). In one such aspect, the input tensor 205 may correspond to a set of indices, each corresponding to a valid input element, and a corresponding input value at each such index. For example, in the illustrated example, the input tensor 205 may indicate that the valid input elements 210 include a value of 13 at index (3, 3) and a value of 7 at index (4, 3).

In the illustrated workflow 200A, the output element component 120 accesses the input tensor 205, along with a kernel 220 (which may correspond to the kernel 110 of FIG. 1) to determine affected output elements for each valid input element (depicted in tables 225A and 225B). That is, the output element component 120 may generate and/or populate a respective table 225 for each valid input element 210 in the input tensor 205. In the illustrated example, the kernel 220 is a 3×3 kernel having nine weights or values: a value of 3 for the top-left element, a value of 2 for the top-center element, a value of 1 for the top-right element, a value of 5 for the center-left element, a value of 6 for the center element, a value of 4 for the center-right element, a value of 2 for the bottom-left element, a value of 4 for the bottom-center element, and a value of 7 for the bottom-right element. In some aspects, as discussed above, the values indicated in the kernel 220 may be learned and/or refined during a training phase based on training data.

In the workflow 200A, the set of affected output elements for each valid input element 210 is determined, by the output element component 120, based on the kernel 220. Specifically, the number of affected output elements for each valid input element 210 (and therefore the size of the corresponding table 225) corresponds to the number of elements in the kernel 220 (also referred to as the size of the kernel 220), with the specific indices of these elements being determined based on the size/shape of the kernel 220. For example, for a 3×3 kernel, the output element component 120 may identify nine affected output elements for each valid input element 210. In the illustrated example, the affected output elements are identified (e.g., by the output element component 120) by identifying which indices (in the input tensor 205) are covered by an element of the kernel 220 when the kernel 220 is placed/centered on the index of a valid input element.

As depicted in the table 225A, the column 230A indicates the index of an affected output element, and the column 235A will be used to indicate the corresponding intermediate value (generated during the workflow 200B of FIG. 2B). Specifically, the table 225A indicates the affected output elements for the valid input element 210A at index (3, 3). This set of affected output elements includes the elements at indices (2, 2), (2, 3), (2, 4), (3, 2), (3, 3), (3, 4), (4, 2), (4, 3), and (4, 4). Similarly, the table 225B indicates the affected output elements for the valid input element 210B at index (4, 3). This set of affected output elements includes the elements at indices (3 2), (3, 3), (3, 4), (4, 2), (4, 3), (4, 4), (5, 2), (5, 3), and (5, 4). In some aspects, the tables 225 may be referred to as hash tables or output hash tables.

The workflow 200B, depicted in FIG. 2B, may be performed by the convolution component 125 of FIG. 1. In the illustrated example, the convolution component 125 uses the determined set of affected output elements for each valid input element 210 (e.g., indicated in the generated output hash tables 225A and 225B), the value of each valid input element (e.g., in the input tensor 205) and the values specified in the kernel 220 to generate intermediate values, which are depicted in column 235A of table 225A for the valid input element 210A, and in column 235B of table 225B for the valid input element 210B. Specifically, for each respective valid input element 210, the convolution component 125 may multiply the respective value of the respective valid input element 210 with each weight of the kernel 220 to generate an intermediate value for a corresponding output index. For example, for each valid input value, the convolution component 125 may use vector-scalar multiplication to generate the intermediate values corresponding to each kernel point. In the depicted example, for two valid input elements 210A and 210B and a kernel 220 of size 9, the convolution component 125 generates 18 different intermediate values.

Specifically, for the valid input element 210A (with a value of 13) at index (3, 3), the convolution component 125 generates an intermediate value of 39 for the output element at index (2, 2) (e.g., 13*3 for the top-left element of the kernel 220), an intermediate value of 26 for the output element at index (2, 3) (e.g., 13*2 for the top-center element of the kernel 220), an intermediate value of 13 for the output element at index (2, 4) (e.g., 13*1 for the top-right element of the kernel 220), an intermediate value of 65 for the output element at index (3, 2) (e.g., 13*5 for the center-left element of the kernel 220), an intermediate value of 78 for the output element at index (3, 3) (e.g., 13*6 for the center element of the kernel 220), an intermediate value of 52 for the output element at index (3, 4) (e.g., 13*4 for the center-right element of the kernel 220), an intermediate value of 26 for the output element at index (4, 2) (e.g., 13*2 for the bottom-left element of the kernel 220), an intermediate value of 52 for the output element at index (4, 3) (e.g., 13*4 for the bottom-center element of the kernel 220), and an intermediate value of 91 for the output element at index (4,4) (e.g., 13*7 for the bottom-right element of the kernel 220).

Further, for the valid input element 210B (with a value of 7) at index (4, 3), the convolution component 125 generates an intermediate value of 21 for the output element at index (3, 2) (e.g., 7*3 for the top-left element of the kernel 220), an intermediate value of 14 for the output element at index (3, 3) (e.g., 7*2 for the top-center element of the kernel 220), an intermediate value of 7 for the output element at index (3, 4) (e.g., 7*1 for the top-right element of the kernel 220), an intermediate value of 35 for the output element at index (4, 2) (e.g., 7*5 for the center-left element of the kernel 220), an intermediate value of 42 for the output element at index (4, 3) (e.g., 7*6 for the center element of the kernel 220), an intermediate value of 28 for the output element at index (4, 4) (e.g., 7*4 for the center-right element of the kernel 220), an intermediate value of 14 for the output element at index (5, 2) (e.g., 7*2 for the bottom-left element of the kernel 220), an intermediate value of 28 for the output element at index (5, 3) (e.g., 7*4 for the bottom-center element of the kernel 220), and an intermediate value of 49 for the output element at index (5, 4) (e.g., 7*7 for the bottom-right element of the kernel 220).

As discussed above, in some aspects, these intermediate values can be generated (e.g., by the convolution component 125) in parallel and/or asynchronously for each valid input element 210 and/or for each affected output element. That is, the convolution component 125 may process multiple valid input element 210 in parallel (e.g., using multithreading). Additionally, for a given valid input element 210, the convolution component 125 may process/generate multiple intermediate values in parallel (e.g., using SIMD operations). In this way, the system can identify affected output elements for the valid input elements and/or generate intermediate values for the affected output elements in parallel and/or asynchronously, allowing for increased flexibility and computational efficiency.

The workflow 200C, depicted in FIG. 2C, may be performed in part by the accumulation component 130 of FIG. 1. In the illustrated example, the accumulation component 130 uses the generated intermediate output values for each valid input element 210 (e.g., indicated in columns 235A and 235B of tables 225A and 225B) to accumulate the values into aggregated convolution output. In the illustrated example, the accumulation component 130 does so using a buffer 250.

In some aspects, the buffer 250 uses a scatter-gather feature, as discussed above. In some aspects, a buffer 250 matching the size of the input tensor is reserved (e.g., in memory or in another location) for performing the scatter-gather or scatter-accumulate. For example, if the input is an image or tensor of size 5×5 (as in the illustrated example) having pixel or element values of 8 bits each, then a 5×5 byte buffer may be reserved in memory (as depicted by buffer 250).

In the illustrated aspect, each location or element in this buffer 250 corresponds to a possible location/element (e.g., pixel) in the input/output. Based on the determined output indices (indicated in tables 225), the accumulation component 130 can place the output of the convolution operations (e.g., the intermediate values indicated in tables 225) at the correct locations/elements in the buffer 250. In an aspect, as discussed above, while placing a given intermediate value in the buffer 250, the value is added with the existing value (if any) in that buffer element/at that location.

Specifically, as illustrated, the buffer element at index (2, 2) has a value of 39 (corresponding to the intermediate value at index (2, 2) in table 225A), the buffer element at index (2, 3) has a value of 26 (corresponding to the intermediate value at index (2, 3) in table 225A), the buffer element at index (2,4) has a value of 13 (corresponding to the intermediate value at index (2, 4) in table 225A), the buffer element at index (5, 2) has a value of 14 (corresponding to the intermediate value at index (5, 2) in table 225B), the buffer element at index (5, 3) has a value of 28 (corresponding to the intermediate value at index (5, 3) in table 225B), and the buffer element at index (5, 4) has a value of 49 (corresponding to the intermediate value at index (5, 4) in table 225B). As illustrated, these buffer elements correspond to the non-overlapping elements (e.g., elements where the value is determined based on a single input element).

Further, as illustrated, several buffer elements include summation to indicate the overlap of the kernel applications (e.g., indices where the kernel is used to generate two or more values, based on two or more valid inputs). Specifically, the buffer element at index (3, 2) has a value of 65+21 (corresponding to the intermediate values at index (3, 2) in tables 225A and 225B), the buffer element at index (3, 3) has a value of 78+14 (corresponding to the intermediate values at index (3, 3) in tables 225A and 225B), the buffer element at index (3, 4) has a value of 52+7 (corresponding to the intermediate values at index (3, 4) in tables 225A and 225B), the buffer element at index (4, 2) has a value of 26+35 (corresponding to the intermediate values at index (4, 2) in tables 225A and 225B), the buffer element at index (4, 3) has a value of 52+42 (corresponding to the intermediate values at index (4, 3) in tables 225A and 225B), and the buffer element at index (4, 4) has a value of 91+28 (corresponding to the intermediate values at index (4,4) in tables 225A and 225B).

Although the illustrated example depicts the aggregated values at the overlapping indices as a summation (e.g., 78+14) for conceptual clarity, in some aspects, as discussed above, the values are summed when placed into the buffer. For example, if the intermediate value of 14 at index (3, 3) is generated first (based on valid input element 210B), then the newly generated intermediate value will be added to a value of zero and placed in the appropriate buffer element. When the intermediate value of 78 at index (3, 3) is generated subsequently or in parallel (based on valid input element 210A), the newly generated intermediate value will be added to the (already-stored) value of 14, and a summed value of 92 will be inserted into the buffer element.

In some aspects, the values depicted in the buffer 250 are referred to as “aggregated” output values to indicate that each represents the accumulation or summation of one or more intermediate values. That is, values at overlapping indices (e.g., the value of 86 at index (3,2)) may be referred to as aggregate output values to indicate that values represent the combination of multiple intermediate values (e.g., values generated based on multiple valid input elements). In some aspects, values at non-overlapping indices (e.g., value 39 at index (2,2)) may similarly be referred to as aggregate output values, even though such values correspond to a single intermediate value, to reflect that the accumulation component 130 has operated on the intermediate value and/or placed the intermediate value in the buffer 250 and the accumulation is complete.

In some aspects, as discussed above, the operations of the output element component 120, the convolution component 125, and the accumulation component 130 are performed for each valid input element. Advantageously, as discussed above, these operations may be performed in parallel for each valid input element in some aspects (e.g., using multithreading), and need not be synchronized.

In the illustrated example, the buffer elements with indices (3, 3) and (4, 3), which are depicted with bold outlines, may be referred to as “valid” output elements to indicate that each has an index that matches an index of a valid input element. Specifically, the buffer element at index (3, 3) corresponds to the valid input element 210A (with a value of 13), and the buffer element at index (4, 3) corresponds to the valid input element 210B (with a value of 7).

In the illustrated example, after the intermediate values have been placed in the buffer 250, the gather component 135 can identify and extract or retrieve these valid output values, resulting in convolution output 255 (which is depicted as a table and may correspond to the convolution output 140 of FIG. 1) that includes a set of valid output indices, each with a corresponding value. In some aspects, as discussed above, the remaining values (at invalid indices that do not correspond to a valid input) may be discarded or otherwise unused. In some aspects, as discussed above, one or more of the valid output values can be generated, extracted, or otherwise gathered or accessed (e.g., by the gather component 135) in parallel and/or asynchronously (e.g., using multithreading). For example, the gather component 135 may identify and extract one or more values from the buffer 250 based on the indices of the valid input elements in parallel to reduce the latency of the convolution operation.

In this way, the sparse convolution system can perform efficient sparse convolution using reduced computational expense and power consumption, as well as with less complex and less expensive hardware that may be more readily accessible on a wider variety of devices and systems, as compared to some conventional sparse convolution approaches.

### Example Method for Performing Sparse Convolution Using Scatter-Accumulate Techniques

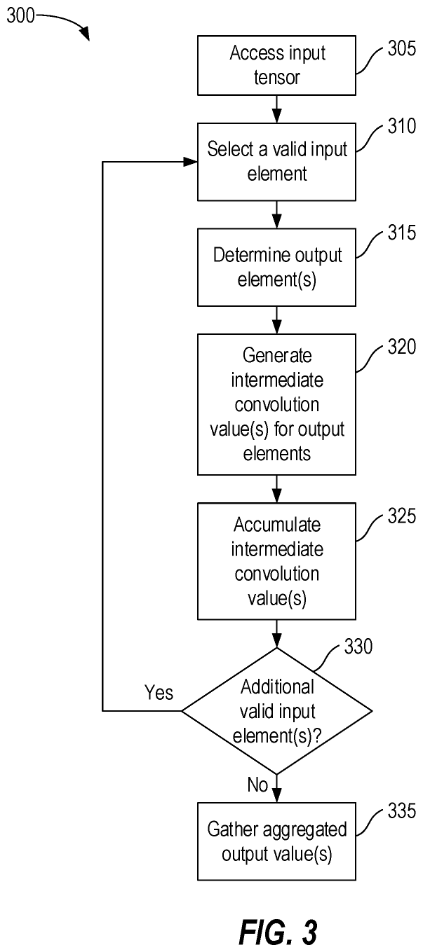

FIG. 3 is a flow diagram depicting an example method 300 for performing sparse convolution using scatter-accumulate techniques. In some aspects, the method 300 may be performed by a sparse convolution system, such as the sparse convolution system 115 of FIG. 1. In some aspects, the method 300 provides additional detail for the workflow 100 of FIG. 1, the workflow 200A of FIG. 2A, the workflow 200B of FIG. 2B, and/or the workflow 200C of FIG. 2C.

At block 305, the sparse convolution system accesses an input tensor (e.g., sparse tensor 105 of FIG. 1 and/or input tensor 205 of FIGS. 2A and 2B) for performing a sparse convolution. In some aspects, as discussed above, the input tensor may include a set of valid (e.g., non-zero) elements. In some aspects, the input tensor may additionally include a set of invalid (e.g., having a value of zero) elements. In other aspects, the input tensor may include a set of indices to indicate the valid elements, along with a corresponding set of values for each such index, without including any invalid elements.

In aspects, as discussed above, the particular size, shape, contents, and/or format of the input tensor may vary depending on the particular implementation. In some aspects, the input tensor may be referred to as a sparse tensor. In at least one aspect, the input tensor includes or corresponds to LIDAR data, as discussed above.

At block 310, the sparse convolution system selects a valid input element. For example, the sparse convolution system may select one of the elements, in the input tensor, having a non-zero value. In some aspects, the sparse convolution system may select the input element using any suitable technique, including randomly or pseudo-randomly, as all valid elements will be processed during the method 300.

Though the illustrated example depicts a sequential process (where each valid input element is selected and evaluated in turn) for conceptual clarity, in some aspects, the sparse convolution system may process some or all of the valid elements simultaneously, as discussed above. That is, the operations indicated by blocks 315, 320, and 325 may be performed, for each valid input element, independently and/or asynchronously entirely or partially in parallel. For example, for each valid input element, a corresponding thread may be used to perform blocks 315, 320, and 325 independently and asynchronously from the other threads/elements.

At block 315, for the selected valid input element (e.g., for each valid element, in a multithread system), the sparse convolution system determines or identifies a set of affected or corresponding output elements. In some aspects, as discussed above, the sparse convolution system identifies the affected output elements based on the size and/or shape of the kernel that will be used to perform the convolution. In some aspects, the sparse convolution system may identify the element indices, in the input tensor, if the kernel is placed in a defined position relative to the selected valid input element (e.g., if the kernel is centered on the selected element). One example workflow for identifying the affected output element indices is discussed above with reference to FIG. 2A.

At block 320, the sparse convolution system generates intermediate convolution values for the identified set of affected output elements. In some aspects, the sparse convolution system generates these intermediate values by multiplying the value of the selected valid input element with each weight (or other value) specified in the kernel, as discussed above. In some aspects, as discussed above, the sparse convolution system may generate one or more of the intermediate values for the selected input element in parallel and/or asynchronously (e.g., using SIMD operations), as discussed above. One example workflow for generating the intermediate values is discussed above with reference to FIG. 2B.

At block 325, the sparse convolution system accumulates the intermediate convolution values to generate aggregated output values. In some aspects, as discussed above, the sparse convolution system accumulates the values using a scatter-gather or scatter-accumulate operation. For example, the sparse convolution system may identify, for each generated intermediate value, a corresponding buffer element in a buffer (e.g., buffer 250 of FIG. 2C), such as based on the index of the output element. In some aspects, the sparse convolution system can then identify the value currently stored in the buffer element (if any), sum the currently stored value with the newly generated value, and store the new sum in the buffer element. In this way, the sparse convolution system can aggregate or accumulate the intermediate values asynchronously, enabling parallel execution of the convolution (e.g., using multiple threads). One example workflow for accumulating the intermediate values is discussed above with reference to FIG. 2C.

At block 330, the sparse convolution system determines whether there is at least one additional valid input element that has not-yet been processed. If so, then the method 300 returns to block 310. Notably, as discussed above, though the illustrated example suggests an iterative process, the sparse convolution system may evaluate some or all of the valid input elements entirely or partially in parallel and/or in an asynchronous manner.

If, at block 330, the sparse convolution system determines that no additional valid input elements remain unprocessed (e.g., all valid input elements have been used to generate intermediate values, and all intermediate values have been accumulated in the buffer), then the method 300 continues to block 335.

At block 335, the sparse convolution system gathers or collects the generated aggregate output values (e.g., from the buffer). For example, in some aspects, as discussed above, the sparse convolution system can identify the buffer elements that correspond to “valid” output elements (e.g., those that correspond to or match the index of a valid input element), and access these values as the output of the convolution operation. That is, in some aspects, the convolution output may include an aggregated output value for each valid input value in the input tensor (with a one-to-one correspondence between output elements and valid input elements). In some aspects, the remaining (invalid) aggregated output elements may be discarded (e.g., the buffer may be reset to zero or otherwise deleted or wiped without performing any further operations using the invalid elements). In some aspects, as discussed above, this gathering process can similarly be performed for multiple valid output elements in parallel (e.g., using a respective thread for each valid index).

In this way, the sparse convolution system can perform efficient sparse convolution using reduced computational expense and power consumption, as well as with less complex and less expensive hardware that may be more readily accessible on a wider variety of devices and systems, as compared to some conventional sparse convolution approaches.

### Example Method for Sparse Convolution

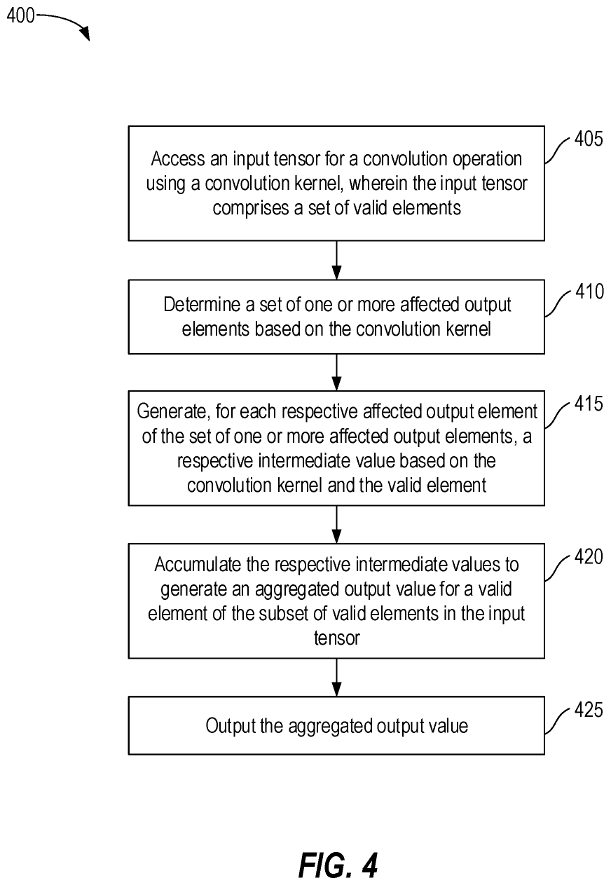

FIG. 4 is a flow diagram depicting an example method 400 for sparse convolution. In some aspects, the method 400 may be performed by a sparse convolution system, such as the sparse convolution system 115 of FIG. 1. In some aspects, the method 300 provides additional detail for the workflow 100 of FIG. 1, the workflow 200A of FIG. 2A, the workflow 200B of FIG. 2B, the workflow 200C of FIG. 2C, and/or the method 300 of FIG. 3.

At block 405, an input tensor for a convolution operation using a convolution kernel is accessed, wherein the input tensor comprises a set of valid elements.

In some aspects, the input tensor is a sparse tensor, and the set of valid elements corresponds to elements having a non-zero value in the input tensor.

In some aspects, the input tensor comprises light detection and ranging (LIDAR) data.

At block 410, a set of one or more affected output elements is determined based on the convolution kernel.

In some aspects, determining the set of one or more affected output elements comprises determining an index of the valid element, and determining a set of indices covered by the convolution kernel when the convolution kernel is centered on the index of the valid element.

At block 415, for each respective affected output element of the set of one or more affected output elements, a respective intermediate value is generated based on the convolution kernel and the valid element.

In some aspects, generating, for each respective affected output element of the set of one or more affected output elements, the respective intermediate value comprises determining, for each respective affected output element of the set of one or more affected output elements, a corresponding element in the convolution kernel, and multiplying a value of the corresponding element in the convolution kernel with a value of the valid element.

In some aspects, generating, for each respective affected output element of the set of one or more affected output elements, the respective intermediate value comprises generating the respective intermediate values in parallel using a single instruction, multiple data (SIMD) operation.

At block 420, the respective intermediate values are accumulated (e.g., in a buffer) to generate an aggregated output value for a valid element of the subset of valid elements in the input tensor.

In some aspects, accumulating the respective intermediate values comprises, for a first intermediate value corresponding to a first affected output element in the set of one or more affected output elements, identifying a buffer element corresponding to the first affected output element, and adding the first intermediate value to a value stored in the buffer element.

At block 425, the aggregated output value is output.

In some aspects, the method 400 further includes generating a set of aggregated output values for the set of valid elements in the input tensor, and outputting the set of aggregated output values.

In some aspects, the set of aggregated output values are generated in parallel.

In some aspects, the method 400 further includes discarding aggregated output values corresponding to one or more invalid elements for the input tensor.

### Example Processing System for Efficient Machine Learning

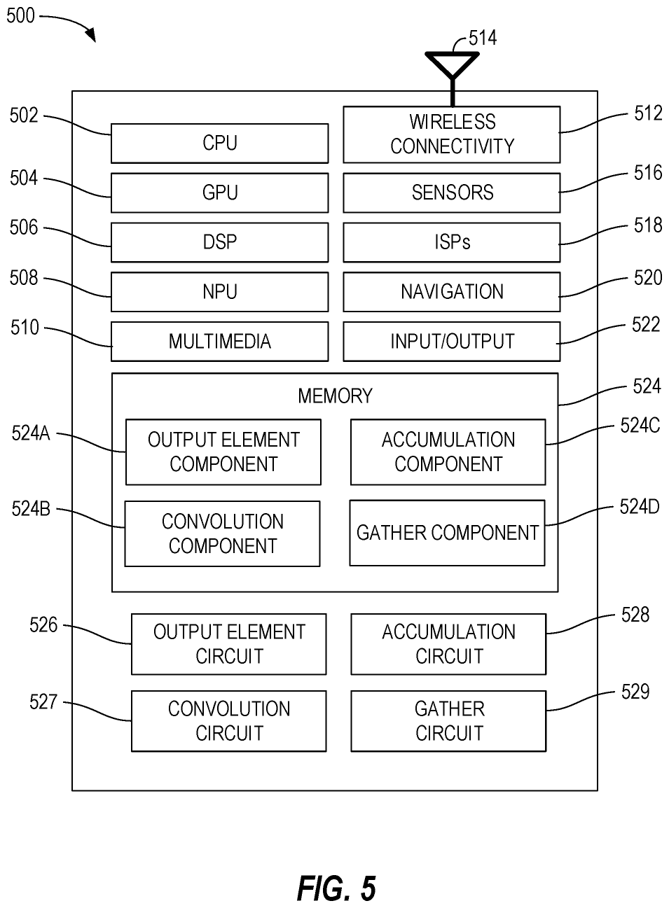

In some aspects, the workflows, architectures, techniques, and methods described with reference to FIGS. 1-4 may be implemented on one or more devices or systems. FIG. 5 depicts an example processing system 500 configured to perform various aspects of the present disclosure, including, for example, the techniques and methods described with respect to FIGS. 1-4. In one aspect, the processing system 500 corresponds to a sparse convolution system, such as the sparse convolution system 115 of FIG. 1. Although depicted as a single system for conceptual clarity, in at least some aspects, as discussed above, the operations described below with respect to the processing system 500 may be distributed across any number of devices.

Processing system 500 includes a central processing unit (CPU) 502, which in some examples may be a multi-core CPU. Instructions executed at the CPU 502 may be loaded, for example, from a program memory associated with the CPU 502 or may be loaded from a partition of memory 524.

Processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In one implementation, NPU 508 is a part of one or more of CPU 502, GPU 504, and/or DSP 506.

In some examples, wireless connectivity component 512 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 512 is further connected to one or more antennas 514.

Processing system 500 may also include one or more sensor processing units 516 associated with any manner of sensor, one or more image signal processors (ISPs) 518 associated with any manner of image sensor, and/or a navigation component 520, which may include satellite-based positioning system components (e.g., GPS or GLONASS) as well as inertial positioning system components.

Processing system 500 may also include one or more input and/or output devices 522, such as screens, touch-sensitive surfaces (including touch-sensitive displays), physical buttons, speakers, microphones, and the like.

In some examples, one or more of the processors of processing system 500 may be based on an ARM or RISC-V instruction set.

Processing system 500 also includes memory 524, which is representative of one or more static and/or dynamic memories, such as a dynamic random access memory, a flash-based static memory, and the like. In this example, memory 524 includes computer-executable components, which may be executed by one or more of the aforementioned processors of processing system 500.

In particular, in this example, memory 524 includes an output element component 524A, a convolution component 524B, an accumulation component 524C, and a gather component 524D. Though depicted as discrete components for conceptual clarity in FIG. 5, the illustrated components (and others not depicted) may be collectively or individually implemented in various aspects. Additionally, though depicted as residing on the same processing system 500, in some aspects, training and inferencing may be performed on separate systems.

Although not included in the illustrated example, in some aspects, the memory 524 may further include other data, such as model parameters (e.g., kernel weights) and model hyperparameters.

Processing system 500 further comprises an output element circuit 526, a convolution circuit 527, an accumulation circuit 528, and a gather circuit 529. The depicted circuits, and others not depicted, may be configured to perform various aspects of the techniques described herein.

In an aspect, output element component 524A and/or output element circuit 526 may generally be used to identify, for each valid input element, a corresponding set of affected output elements. For example, as discussed above with reference to FIG. 2A, the output element component 524A and/or output element circuit 526 may identify the indices that are covered by the kernel when the kernel is positioned in a defined location relative to the input element (e.g., centered on the valid input element).

In an aspect, the convolution component 524B and/or convolution circuit 527 may generally be used to generate intermediate values for each affected output element in each of the identified sets of affected output elements, as discussed above. For example, as discussed above with reference to FIG. 2B, the convolution component 524B and/or convolution circuit 527 may, for each respective valid input element, multiply the value of the respective valid input element with each weight indicated in the convolution kernel.

In an aspect, the accumulation component 524C and/or accumulation circuit 528 may generally be used to accumulate generated intermediate values for each affected output element in each of the identified sets of affected output elements, as discussed above. For example, as discussed above with reference to FIG. 2C, the accumulation component 524C and/or accumulation circuit 528 may, for each respective affected output element, aggregate (e.g., sum) the corresponding intermediate values.

In an aspect, the gather component 524D and/or gather circuit 529 may generally be used to gather the aggregated output values (e.g., generated by the accumulation component 524C and/or accumulation circuit 528, and/or stored in the buffer) for each the valid output elements, as discussed above. For example, as discussed above with reference to FIG. 2C, the gather component 524D and/or gather circuit 529 may, for each respective valid input element, identify a corresponding valid output element (e.g., the output element having the same index), and extract the aggregated value in the corresponding buffer element.

Though depicted as separate components and circuits for clarity in FIG. 5, output element circuit 526, convolution circuit 527, accumulation circuit 528, and gather circuit 529 may collectively or individually be implemented in other processing devices of processing system 500, such as within CPU 502, GPU 504, DSP 506, NPU 508, and the like.

Generally, processing system 500 and/or components thereof may be configured to perform the methods described herein.

Notably, in other aspects, aspects of processing system 500 may be omitted, such as where processing system 500 is a server computer or the like. For example, multimedia processing unit 510, wireless connectivity component 512, sensor processing units 516, ISPs 518, and/or navigation component 520 may be omitted in other aspects. Further, aspects of processing system 500 maybe distributed between multiple devices.

### Example Clauses

Implementation examples are described in the following numbered clauses:

Clause 1: A method, comprising: accessing an input tensor for a convolution operation using a convolution kernel, wherein the input tensor comprises a set of valid elements; generating an aggregated output value for a valid element of the set of valid elements in the input tensor, comprising: determining a set of one or more affected output elements based on the convolution kernel; generating, for each respective affected output element of the set of one or more affected output elements, a respective intermediate value based on the convolution kernel and the valid element; and accumulating the respective intermediate values to generate the aggregated output value; and outputting the aggregated output value.

Clause 2: A method according to Clause 1, wherein determining the set of one or more affected output elements comprises: determining an index of the valid element; and determining a set of indices covered by the convolution kernel when the convolution kernel is centered on the index of the valid element.

Clause 3: A method according to Clause 1 or 2, wherein generating, for each respective affected output element of the set of one or more affected output elements, the respective intermediate value comprises: determining, for each respective affected output element of the set of one or more affected output elements, a corresponding element in the convolution kernel; and multiplying a value of the corresponding element in the convolution kernel with a value of the valid element.

Clause 4: A method according to any of Clauses 1-3, wherein generating, for each respective affected output element of the set of one or more affected output elements, the respective intermediate value comprises generating the respective intermediate values in parallel using a single instruction, multiple data (SIMD) operation.

Clause 5: A method according to any of Clauses 1-4, wherein accumulating the respective intermediate values comprises, for a first intermediate value corresponding to a first affected output element in the set of one or more affected output elements: identifying a buffer element corresponding to the first affected output element; and adding the first intermediate value to a value stored in the buffer element.

Clause 6: A method according to any of Clauses 1-5, further comprising: generating a set of aggregated output values for the subset of valid elements in the input tensor; and outputting the set of aggregated output values.

Clause 7: A method according to any of Clauses 6, wherein the set of aggregated output values are generated in parallel.

Clause 8: A method according to Clause 6 or Clause 7, further comprising discarding aggregated output values corresponding to one or more invalid elements for the input tensor.

Clause 9: A method according to any of Clauses 1-8, wherein: the input tensor is a sparse tensor, and the set of valid elements corresponds to elements having a non-zero value in the input tensor.

Clause 10: A method according to any of Clauses 1-9, wherein the input tensor comprises light detection and ranging (LIDAR) data.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
accessing an input tensor for a convolution operation using a convolution kernel, wherein the input tensor comprises a set of valid elements;
generating an aggregated output value for a valid element of the set of valid elements in the input tensor, comprising:
determining a set of one or more affected output elements based on the convolution kernel;
generating, for each respective affected output element of the set of one or more affected output elements, a respective intermediate value based on the convolution kernel and the valid element; and
accumulating the respective intermediate values to generate the aggregated output value; and
outputting the aggregated output value.

2. The processor-implemented method of claim 1, wherein determining the set of one or more affected output elements comprises:
determining an index of the valid element; and
determining a set of indices covered by the convolution kernel when the convolution kernel is centered on the index of the valid element.

3. The processor-implemented method of claim 1, wherein generating, for each respective affected output element of the set of one or more affected output elements, the respective intermediate value comprises:
determining, for each respective affected output element of the set of one or more affected output elements, a corresponding element in the convolution kernel; and
multiplying a value of the corresponding element in the convolution kernel with a value of the valid element.

4. The processor-implemented method of claim 1, wherein generating, for each respective affected output element of the set of one or more affected output elements, the respective intermediate value comprises generating the respective intermediate values in parallel using a single instruction, multiple data (SIMD) operation.

5. The processor-implemented method of claim 1, wherein accumulating the respective intermediate values comprises, for a first intermediate value corresponding to a first affected output element in the set of one or more affected output elements:
identifying a buffer element corresponding to the first affected output element; and
adding the first intermediate value to a value stored in the buffer element.

6. The processor-implemented method of claim 1, further comprising:
generating a set of aggregated output values for the set of valid elements in the input tensor; and
outputting the set of aggregated output values.

7. The processor-implemented method of claim 6, wherein the set of aggregated output values are generated in parallel.

8. The processor-implemented method of claim 6, further comprising discarding aggregated output values corresponding to one or more invalid elements for the input tensor.

9. The processor-implemented method of claim 1, wherein:
the input tensor is a sparse tensor, and
the set of valid elements corresponds to elements having a non-zero value in the input tensor.

10. The processor-implemented method of claim 1, wherein the input tensor comprises light detection and ranging (LIDAR) data.

11. A processing system comprising:
a memory comprising computer-executable instructions; and
one or more processors configured to execute the computer-executable instructions and cause the processing system to perform an operation comprising:
accessing an input tensor for a convolution operation using a convolution kernel, wherein the input tensor comprises a set of valid elements;
generating an aggregated output value for a valid element of the set of valid elements in the input tensor, comprising:
determining a set of one or more affected output elements based on the convolution kernel;
generating, for each respective affected output element of the set of one or more affected output elements, a respective intermediate value based on the convolution kernel and the valid element; and
accumulating the respective intermediate values to generate the aggregated output value; and
outputting the aggregated output value.

12. The processing system of claim 11, wherein determining the set of one or more affected output elements comprises:
determining an index of the valid element; and
determining a set of indices covered by the convolution kernel when the convolution kernel is centered on the index of the valid element.

13. The processing system of claim 11, wherein generating, for each respective affected output element of the set of one or more affected output elements, the respective intermediate value comprises:
determining, for each respective affected output element of the set of one or more affected output elements, a corresponding element in the convolution kernel; and
multiplying a value of the corresponding element in the convolution kernel with a value of the valid element.

14. The processing system of claim 11, wherein generating, for each respective affected output element of the set of one or more affected output elements, the respective intermediate value comprises generating the respective intermediate values in parallel using a single instruction, multiple data (SEID) operation.

15. The processing system of claim 11, wherein accumulating the respective intermediate values comprises, for a first intermediate value corresponding to a first affected output element in the set of one or more affected output elements:
identifying a buffer element corresponding to the first affected output element; and
adding the first intermediate value to a value stored in the buffer element.

16. The processing system of claim 11, the operation further comprising:
generating a set of aggregated output values for the set of valid elements in the input tensor; and
outputting the set of aggregated output values.

17. The processing system of claim 16, wherein the set of aggregated output values are generated in parallel.

18. The processing system of claim 16, the operation further comprising discarding aggregated output values corresponding to one or more invalid elements for the input tensor.

19. The processing system of claim 11, wherein:
the input tensor is a sparse tensor, and
the set of valid elements corresponds to elements having a non-zero value in the input tensor.

20. The processing system of claim 11, wherein the input tensor comprises light detection and ranging (LIDAR) data.

21. A non-transitory computer-readable medium comprising computer-executable instructions that, when executed by one or more processors of a processing system, cause the processing system to perform an operation comprising:
accessing an input tensor for a convolution operation using a convolution kernel, wherein the input tensor comprises a set of valid elements;
generating an aggregated output value for a valid element of the set of valid elements in the input tensor, comprising:
determining a set of one or more affected output elements based on the convolution kernel;
generating, for each respective affected output element of the set of one or more affected output elements, a respective intermediate value based on the convolution kernel and the valid element; and
accumulating the respective intermediate values to generate the aggregated output value; and
outputting the aggregated output value.

22. The non-transitory computer-readable medium of claim 21, wherein determining the set of one or more affected output elements comprises:
determining an index of the valid element; and
determining a set of indices covered by the convolution kernel when the convolution kernel is centered on the index of the valid element.

23. The non-transitory computer-readable medium of claim 21, wherein generating, for each respective affected output element of the set of one or more affected output elements, the respective intermediate value comprises:
determining, for each respective affected output element of the set of one or more affected output elements, a corresponding element in the convolution kernel; and
multiplying a value of the corresponding element in the convolution kernel with a value of the valid element.

24. The non-transitory computer-readable medium of claim 21, wherein generating, for each respective affected output element of the set of one or more affected output elements, the respective intermediate value comprises generating the respective intermediate values in parallel using a single instruction, multiple data (SIMD) operation.

25. The non-transitory computer-readable medium of claim 21, wherein accumulating the respective intermediate values comprises, for a first intermediate value corresponding to a first affected output element in the set of one or more affected output elements:
identifying a buffer element corresponding to the first affected output element; and
adding the first intermediate value to a value stored in the buffer element.

26. The non-transitory computer-readable medium of claim 21, the operation further comprising:
generating a set of aggregated output values for the set of valid elements in the input tensor; and
outputting the set of aggregated output values.

27. The non-transitory computer-readable medium of claim 26, wherein the set of aggregated output values are generated in parallel.

28. The non-transitory computer-readable medium of claim 26, the operation further comprising discarding aggregated output values corresponding to one or more invalid elements for the input tensor.

29. The non-transitory computer-readable medium of claim 21, wherein:
the input tensor is a sparse tensor, and
the set of valid elements corresponds to elements having a non-zero value in the input tensor.

30. A processing system, comprising:
means for accessing an input tensor for a convolution operation using a convolution kernel, wherein the input tensor comprises a set of valid elements;
means for generating an aggregated output value for a valid element of the set of valid elements in the input tensor, comprising:
means for determining a set of one or more affected output elements based on the convolution kernel;
means for generating, for each respective affected output element of the set of one or more affected output elements, a respective intermediate value based on the convolution kernel and the valid element; and
means for accumulating the respective intermediate values to generate the aggregated output value; and
means for outputting the aggregated output value.
